(19) United States
(12) Patent Application Publication
(10) Pub. No.: US 2026/0341083 A1
(43) Pub. Date: Oct. 29, 2026

(54) METHOD AND APPARATUS FOR DETECTING AND TRACING VEHICLE EMISSION ANOMALIES AND ELECTRONIC DEVICE

(71) Applicant: CATARC AUTOMOTIVE TEST CENTER (TIANJIN) CO., LTD, Tianjin (CN)

(72) Inventors: Hanzhengnan YU, Tianjin (CN); Hao ZHANG, Tianjin (CN); Yu LIU, Tianjin (CN); Bin TIAN, Tianjin (CN); Xiaoyi HOU, Tianjin (CN); Jingyuan LI, Tianjin (CN); Hang XU, Tianjin (CN); Yongkai LIANG, Tianjin (CN); Xiaopan AN, Tianjin (CN); Wang GAO, Tianjin (CN); Xionghui ZOU, Tianjin (CN); Zhenkai XIE, Tianjin (CN); Yantao DOU, Tianjin (CN); Guogang QIAN, Tianjin (CN)

(21) Appl. No.: 19/357,839

(22) Filed: Oct. 14, 2025

(30) Foreign Application Priority Data
Apr. 22, 2025 (CN) 2025105051578

(51) Int. Cl. G07C 5/04; G07C 5/06

(52) U.S. Cl. CPC G07C 5/04; G07C 5/06

(57) ABSTRACT

The present invention relates to the technical field of transportation, in particular to a method and apparatus for detecting and tracing vehicle emission anomalies and an electronic device. The method includes: inputting a current operating condition and current operating data into a dynamic threshold model to obtain a first detection result, and inputting the same into an emission prediction model to obtain a second detection result; when the first detection result and the second detection result fail to meet a preset condition for determining vehicle emission anomalies, integrating the first detection result and the second detection result to obtain a final detection result; when the final detection result is higher than or equal to a preset threshold, determining that a vehicle has an emission anomaly; and obtaining a cause and probability of the emission anomaly using a Cosine similarity calculation strategy, based on a vehicle emission anomaly knowledge graph database.

### CROSS-REFERENCE TO RELATED APPLICATION

This application claims priority from the Chinese patent application 2025105051578 filed Apr. 22, 2025, the content of which is incorporated herein in the entirety by reference.

### TECHNICAL FIELD

The present invention relates to the technical field of transportation, in particular to a method and apparatus for detecting and tracing vehicle emission anomalies and an electronic device.

### BACKGROUND ART

Traditional methods for detecting vehicle emission anomalies mostly rely on single-threshold detection (such as a fixed nitrogen oxide (NOX) limit value) or manual experience judgment, which have the following technical challenges:

(1) data fragmentation and inefficient analysis: emission anomalies involve the coupled effects of multiple components such as an engine and aftertreatment systems (e.g., Selective Catalytic Reduction (SCR) system, Diesel Particulate Filter (DPF)). Traditional methods rely on scattered sensor data or manual experience, and are difficult to integrate multi-source heterogeneous information such as maintenance cases, real-time data from vehicle terminals and literature knowledge, resulting in low efficiency in positioning of fault causes;

(2) poor adaptability of static thresholds: existing threshold models usually adopt fixed limit values while ignoring dynamic differences in actual vehicle operating conditions (such as urban congestion, highway cruising, and low-temperature cold starts), thereby being likely to trigger false alarms or missed detections due to fluctuation of operating conditions;

(3) insufficient causal reasoning capability: the correlation between root causes and manifestations of emission anomalies is complex (for example, “urea pump blockage→excessive NOx” requires multi-level transmission). Traditional rule engines or statistical methods are difficult to model deep causal relationships, resulting in low accuracy of anomaly tracing; and

(4) lag in knowledge updating: maintenance experience and new fault cases rely on manual summarization, leading to long update cycles of a knowledge database, and the incapability of adapting to the rapid iteration of emission control technologies.

### SUMMARY

The present invention provides a method and apparatus for detecting and tracing vehicle emission anomalies and an electronic device, so as to solve the problems such as low detection efficiency, high misjudgment rate and difficulty in tracing caused by data fragmentation and complex causal relationships of traditional methods for detecting and tracing vehicle emission anomalies.

In a first aspect, an embodiment of the present invention provide a method for detecting and tracing vehicle emission anomalies, comprising the following steps: acquiring a current operating condition and current operating data of a vehicle; inputting the same into a preset dynamic threshold model to obtain a first detection result, and inputting the same into a preset emission prediction model to obtain a second detection result, wherein the preset dynamic threshold model is constructed based on a plurality of preset operating conditions and a preset emission anomaly threshold corresponding to each preset operating condition, and the preset emission prediction model is obtained by training a long short-term memory (LSTM) neural network using historical operating data of the vehicle; when the first detection result and the second detection result fail to meet a preset condition for determining vehicle emission anomalies, integrating the first detection result and the second detection result to obtain a final detection result; when the final detection result is higher than or equal to a preset threshold, determining that the vehicle has an emission anomaly, and obtaining a cause and probability of the vehicle emission anomaly using a Cosine similarity calculation strategy, based on a preset vehicle emission anomaly knowledge graph database.

Optionally, the first detection result comprises an actual emission amount of the vehicle, and determining whether the first detection result meets the preset condition for determining vehicle emission anomalies further comprises: determining whether the actual emission amount of the vehicle is larger than a preset emission anomaly threshold, and determining whether a first duration during which the actual emission amount of the vehicle is larger than the preset emission anomaly threshold is longer than a first preset duration, wherein the preset emission anomaly threshold is obtained according to the current operating condition; in a case where the actual emission amount of the vehicle is larger than the preset emission anomaly threshold and the first duration is longer than the first preset duration, determining that the first detection result meets the preset condition for determining vehicle emission anomalies, and that the vehicle has the emission anomaly, and the cause and probability of the vehicle emission anomaly are obtained using the Cosine similarity calculation strategy, based on the preset vehicle emission anomaly knowledge graph database; otherwise, determining that the first detection result does not meet the preset condition for determining vehicle emission anomalies.

Optionally, prior to determining whether the first detection result is higher than the preset emission anomaly threshold, the method further comprises: acquiring historical operating data of the vehicle; constructing the plurality of preset operating conditions according to data features in the historical operating data; and establishing a mapping relationship between the historical operating data of each preset operating condition and the emission anomaly threshold, so as to obtain the preset emission anomaly threshold according to the current operating condition based on the mapping relationship.

Optionally, the second detection result comprises the actual emission amount of the vehicle, and after the current operating condition and the current operating data are input into the preset emission prediction model to obtain the second detection result, the method further comprises: determining whether a ratio of the actual emission amount of the vehicle to a predicted emission value is larger than a preset ratio and whether second duration during which the actual emission amount of the vehicle is larger than the predicted emission value is longer than a second preset duration; in a case where the ratio of the actual emission amount of the vehicle to the predicted emission value is larger than the preset ratio and the second duration is longer than the second preset duration, determining that the second detection result meets the preset condition for determining vehicle emission anomalies, and that the vehicle has the emission anomaly, and obtaining the cause and probability of the vehicle emission anomaly using the Cosine similarity calculation strategy, based on the preset vehicle emission anomaly knowledge graph database; otherwise, determining that the second detection result does not meet the preset condition for determining vehicle emission anomalies.

Optionally, obtaining the cause and probability of the vehicle emission anomalies using the Cosine similarity calculation strategy, based on the preset vehicle emission anomaly knowledge graph database comprises: acquiring historical operating data of the vehicle; calculating data features of each relationship chain in the preset vehicle emission anomaly knowledge graph database using the Cosine similarity calculation strategy, based on the historical operating data, so as to obtain a plurality of Cosine similarity calculation results; and ranking the plurality of Cosine similarity calculation results according to a preset ranking strategy, and taking the Cosine similarity calculation results meeting a preset ranking condition in the ranking results as the cause and probability of the vehicle emission anomaly.

Optionally, prior to obtaining the cause and probability of the vehicle emission anomaly using the Cosine similarity calculation strategy, based on the preset vehicle emission anomaly knowledge graph database, the method comprises: acquiring vehicle emission anomaly cause data; forming a vehicle emission anomaly cause data relationship chain based on the vehicle emission anomaly cause data; transforming the vehicle emission anomaly cause data relationship chain into entities and relationships in a knowledge graph using a preset knowledge graph theory; and performing entity integration on relatively conflicting entities using an entity alignment strategy so as to obtain the preset vehicle emission anomaly knowledge graph database.

Optionally, integrating the first detection result and the second detection result to obtain a final detection result comprises: integrating the first detection result and the second detection result using a preset integration formula to obtain the final detection result, wherein the preset integration formula is as follows:

$$( \frac{{E}_{c a r}}{{E}_{T h}} \times a + \frac{{E}_{c a r}}{{E}_{P v}} \times b ) ;$$

wherein

$$( \frac{{E}_{c a r}}{{E}_{T h}} \times a + \frac{{E}_{c a r}}{{E}_{P v}} \times b )$$

is the final detection result, E_{car} is the actual emission amount of the vehicle, E_{Th} is the preset emission anomaly threshold, E_{Pv} is the predicted emission value, a is a weight of the first detection result, and b is a weight of the second detection result.

Optionally, after determining that the vehicle has the emission anomaly, and the cause and probability of the vehicle emission anomaly are obtained using the Cosine similarity calculation strategy, based on the preset vehicle emission anomaly knowledge graph database, the method comprises: transmitting vehicle emission anomaly early warning information to a preset terminal; and generating vehicle maintenance recommendations using an AI model based on the vehicle emission anomaly early warning information and the cause and probability of the vehicle emission anomaly.

In a second aspect, an embodiment of the present invention provide an apparatus for detecting and tracing vehicle emission anomalies, comprising: an acquisition module, configured to acquire a current operating condition and current operating data of a vehicle; a detection module, configured to input the current operating condition and current operating data into a preset dynamic threshold model to obtain a first detection result, and input the same into a preset emission prediction model to obtain a second detection result, wherein the preset dynamic threshold model is constructed based on a plurality of preset operating conditions and a preset emission anomaly threshold corresponding to each preset operating condition, and the preset emission prediction model is obtained by training a long short-term memory (LSTM) neural network using historical operating data of the vehicle; and a tracing module, configured to integrate the first detection result and the second detection result to obtain a final detection result when the first detection result and the second detection result fail to meet a preset condition for determining vehicle emission anomalies, determine that the vehicle has an emission anomaly when the final detection result is higher than or equal to a preset threshold, and obtain a cause and probability of the vehicle emission anomaly using a Cosine similarity calculation strategy, based on a preset vehicle emission anomaly knowledge graph database.

Optionally, the first detection result comprises an actual emission amount of the vehicle, and when determining whether the first detection result meets the preset condition for determining vehicle emission anomalies, the detection module is further configured to: determine whether an actual emission amount of the vehicle is larger than a preset emission anomaly threshold, and determine whether a first duration during which the actual emission amount of the vehicle is larger than the preset emission anomaly threshold is longer than a first preset duration, wherein the preset emission anomaly threshold is obtained according to the current operating condition; in a case where the actual emission amount of the vehicle is larger than the preset emission anomaly threshold and the first duration is longer than the first preset duration, determine that the first detection result meets the preset condition for determining vehicle emission anomalies, and that the vehicle has the emission anomaly, and obtain the cause and probability of the vehicle emission anomalies using the Cosine similarity calculation strategy, based on the preset vehicle emission anomaly knowledge graph database; otherwise, determine that the first detection result does not meet the preset condition for determining vehicle emission anomalies.

Optionally, prior to determining whether the first detection result is larger than the preset emission anomaly threshold, the detection module is further configured to: acquire historical operating data of the vehicle; construct the plurality of preset operating conditions according to data features in the historical operating data; and establish a mapping relationship between the historical operating data of each preset operating condition and the emission anomaly threshold, so as to obtain the preset emission anomaly threshold according to the current operating condition based on the mapping relationship.

Optionally, the second detection result comprises the actual emission amount of the vehicle, after determining that the second detection result meets the preset condition for determining vehicle emission anomalies, the detection module is further configured to: determine whether a ratio of the actual emission amount of the vehicle to a predicted emission value is larger than a preset ratio and whether a second duration during which the actual emission amount of the vehicle is larger than the predicted emission value is longer than a second preset duration; in a case where the ratio of the actual emission amount of the vehicle to the predicted emission value is larger than the preset ratio and the second duration is longer than the second preset duration, determine that the second detection result meets the preset condition for determining vehicle emission anomalies, and that the vehicle has the emission anomaly, and obtain the cause and probability of the vehicle emission anomaly using the Cosine similarity calculation strategy, based on the preset vehicle emission anomaly knowledge graph database; otherwise, determine that the second detection result does not meet the preset condition for determining vehicle emission anomalies.

Optionally, the tracing module is further configured to: acquire historical operating data of the vehicle; calculate data features of each relationship chain in the preset vehicle emission anomaly knowledge graph database using the Cosine similarity calculation strategy, based on the historical operating data, so as to obtain a plurality of Cosine similarity calculation results; and rank the plurality of the Cosine similarity calculation results according to a preset ranking strategy, and take the Cosine similarity calculation results meeting a preset ranking condition in the ranking results as the cause and probability of the vehicle emission anomaly.

Optionally, prior to obtaining the cause and probability of the vehicle emission anomaly using the Cosine similarity calculation strategy, based on the preset vehicle emission anomaly knowledge graph database, the tracing module is further configured to: acquire vehicle emission anomaly cause data; form a vehicle emission anomaly cause data relationship chain based on the vehicle emission anomaly cause data; transform the vehicle emission anomaly cause data relationship chain into entities and relationships in a knowledge graph using a preset knowledge graph theory; and perform entity fusion on relatively conflicting entities using an entity alignment strategy so as to obtain the preset vehicle emission anomaly knowledge graph database.

Optionally, the tracing module is further configured to: integrate the first detection result and the second detection result using a preset integration formula to obtain the final detection result, wherein the preset integration formula is as follows:

$$( \frac{{E}_{c a r}}{{E}_{T h}} \times a + \frac{{E}_{c a r}}{{E}_{P v}} \times b ) ;$$

wherein

$$( \frac{{E}_{c a r}}{{E}_{T h}} \times a + \frac{{E}_{c a r}}{{E}_{P v}} \times b )$$

is the final detection result, E_{car} is the actual emission amount of the vehicle, E_{Th} is the preset emission anomaly threshold, E_{Pv} is the predicted emission value, a is a weight of the first detection result, and b is a weight of the second detection result.

Optionally, after determining that the vehicle has the emission anomaly, and the cause and probability of the vehicle emission anomaly are obtained using the Cosine similarity calculation strategy, based on the preset vehicle emission anomaly knowledge graph database, the tracing module is further configured to: transmit vehicle emission anomaly early warning information to a preset terminal; and generate vehicle maintenance recommendations using an AI model based on the vehicle emission anomaly early warning information and the cause and probability of the vehicle emission anomaly.

In a third aspect, an embodiment of the present invention provides an electronic device, comprising a memory, a processor, and a computer program stored in the memory and capable of running on the processor, and the processor implements the computer program to implement the method for detecting and tracing the vehicle emission anomalies in the above embodiment.

In a fourth aspect, an embodiment of the present invention provides a computer program product, in which a computer program is stored, and the program is executed by a processor to implement the method for detecting and tracing the vehicle emission anomalies in the above embodiment.

In the above embodiment, the current operating condition and the current operating data are input into the preset dynamic threshold model to obtain the first detection result, and the current operating condition and the current operating data are input into the preset emission prediction model to obtain the second detection result, wherein the preset dynamic threshold model is constructed based on a plurality of preset operating conditions and a corresponding preset emission anomaly threshold for each preset operating condition, and the preset emission prediction model is obtained by training an LSTM neural network using the historical operating data of the vehicle; when the first detection result and the second detection result fail to meet the preset condition for determining the vehicle emission anomaly, the first detection result and the second detection result are integrated to obtain the final detection result, when the final detection result is higher than or equal to the preset threshold, it is determined that the vehicle has the emission anomaly, and the cause and probability of the vehicle emission anomaly are obtained using the Cosine similarity calculation strategy, based on the vehicle emission anomaly knowledge graph database. Accordingly, the problems of low detection efficiency, high misjudgment rate, and difficulty in tracing of emission anomalies due to data fragmentation and complex causal relationships in traditional methods for detecting and tracing vehicle emission anomalies are solved, accurate detection of the emission anomalies is achieved, closed-loop management from anomaly triggering to root cause tracing is completed, and the purposes of reducing vehicle emission pollution, improving the level of intelligent operation and maintenance, and ensuring environmental protection compliance are achieved.

Advantages of additional aspects of the present invention will be partially described in the following description, part of which will become apparent from the following descriptions, or understood through practice of the present invention.

### BRIEF DESCRIPTION OF THE DRAWINGS

The above and/or additional aspects and advantages of the present invention will be apparent and easily understood from the description of the embodiments taken in conjunction with the following drawings, in which:

FIG. 1 is a flowchart of a method for detecting and tracing vehicle emission anomalies provided according to an embodiment of the present invention;

FIG. 2A is a flowchart illustrating a detection mechanism based on a dynamic threshold model and an LSTM machine learning model according to one embodiment of the present invention, and FIG. 2B is a flowchart illustrating a collaborative detection mechanism established by integrating the dynamic threshold model and the LSTM machine learning model according to one embodiment of the present invention;

FIG. 3 is a flowchart of a method for detecting and tracing vehicle emission anomalies provided according to another embodiment of the present invention;

FIG. 4 is a schematic diagram of a vehicle emission anomaly cause knowledge graph according to one embodiment of the present invention;

FIG. 5 is a schematic diagram of an apparatus for detecting and tracing vehicle emission anomalies according to an embodiment of the present invention; and

FIG. 6 is a schematic structural diagram of an electronic device according to an embodiment of the present invention.

### DETAILED DESCRIPTION OF THE EMBODIMENTS

Embodiments of the present invention are described in details below, and examples of the embodiments are shown in drawings, wherein the same or similar numbers throughout indicate the same or similar elements or elements with the same or similar functions. The embodiments described with reference to the drawings below are exemplary, and are intended only to explain the present invention and cannot be understood as a limit to the present invention.

A method and apparatus for detecting and tracing vehicle emission anomalies and an electronic device provided by embodiments of the present invention will be described below with reference to the accompanying drawings. In view of the problems of low detection efficiency, high misjudgment rate, and difficulty in tracing caused by data fragmentation and complex causal relationships in traditional methods for detecting and tracing vehicle emission anomalies as mentioned in the background art, the present invention provides a method for detecting and tracing vehicle emission anomalies. In the method, a current operating condition and current operating data are input into a preset dynamic threshold model to obtain a first detection result, and the current operating condition and the current operating data are input into a preset emission prediction model to obtain a second detection result, wherein the preset dynamic threshold model is constructed based on a plurality of preset operating conditions and a corresponding preset emission anomaly threshold for each preset operating condition, and the preset emission prediction model is obtained by training an LSTM neural network using historical operating data of a vehicle; when the first detection result and the second detection result fail to meet a preset condition for determining vehicle emission anomalies, the first detection result and the second detection result are integrated to obtain a final detection result, when the final detection result is higher than or equal to a preset threshold, it is determined that the vehicle has an emission anomaly, and a cause and probability of the vehicle emission anomaly are obtained using a Cosine similarity calculation strategy, based on a vehicle emission anomaly knowledge graph database. Accordingly, the problems of low detection efficiency, high misjudgment rate, and difficulty in tracing of emission anomalies due to data fragmentation and complex causal relationships in traditional methods for detecting and tracing vehicle emission anomalies are solved, accurate detection of the emission anomalies is achieved, closed-loop management from anomaly triggering to root cause tracing is completed, and the purposes of reducing vehicle emission pollution, improving the level of intelligent operation and maintenance, and ensuring environmental protection compliance are achieved.

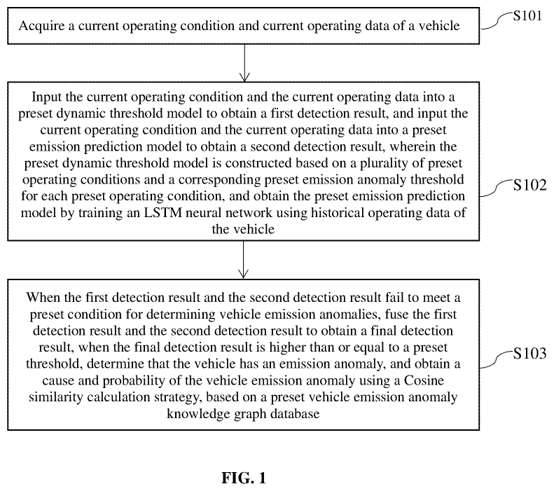

Specifically, FIG. 1 is a flowchart of a method for detecting and tracing vehicle emission anomalies provided according to an embodiment of the present invention.

As shown in FIG. 1, the method for detecting and tracing the vehicle emission anomalies comprises the following steps.

In step S101, a current operating condition and current operating data of a vehicle are acquired.

The current operating data comprises vehicle speed, acceleration, net output torque of an engine, engine speed, engine fuel flow, engine coolant temperature, DPF differential pressure, DPF regeneration frequency, ambient temperature, intake pressure, exhaust temperature, exhaust back pressure, air-fuel ratio, exhaust gas recirculation (EGR) valve opening, urea injection quantity, particulate matter concentration, and an output value of an SCR downstream NOx sensor. The current operating condition comprises one of an urban/suburban condition, highway cruising condition, low-temperature cold start condition and climbing condition.

In step S102, the current operating condition and the current operating data are input into a preset dynamic threshold model to obtain a first detection result, and the current operating condition and the current operating data are input into a preset emission prediction model to obtain a second detection result, wherein the preset dynamic threshold model is constructed based on a plurality of preset operating conditions and a corresponding preset emission anomaly threshold for each preset operating condition, and the preset emission prediction model is obtained by training an LSTM neural network using historical operating data of the vehicle.

The preset emission prediction model is also an LSTM model.

Optionally, in some embodiments, prior to determining whether the first detection result is higher than the preset emission anomaly threshold, the method further comprises: acquiring historical operating data of the vehicle; constructing the plurality of preset operating conditions according to data features in the historical operating data; and establishing a mapping relationship between the historical operating data of each preset operating condition and the emission anomaly threshold, so as to obtain the preset emission anomaly threshold according to the current operating condition based on the mapping relationship.

Specifically, the steps of constructing the preset dynamic threshold model are as follows.

In step 1, four categories of preset operating conditions are established: urban/suburban condition (vehicle speed lower than 50 km/h and idling ratio higher than 18%), highway cruising condition (vehicle speed higher than 70 km/h and throttle opening fluctuation rate lower than 10%), climbing condition (engine torque higher than 70% and road gradient greater than 6%), and low-temperature cold start condition (coolant temperature lower than 40 °C and ambient temperature lower than 10 °C).

In step 2, the historical operating data is processed using a 30-second moving window average method, the data is divided into the urban/suburban condition, highway cruising condition, climbing condition, and low-temperature cold start condition according to data features, and a 95th percentile of NOx emissions under each operating condition is calculated as the preset emission anomaly threshold (for example, the NOx emission anomaly threshold for the urban/suburban condition is 500 ppm), thereby establishing the mapping relationship between the historical operating data of each preset operating condition and the corresponding emission anomaly threshold.

Optionally, in some embodiments, the first detection result comprises an actual emission amount of the vehicle, and determining whether the first detection result meets the preset condition for determining vehicle emission anomalies further comprises: determining whether the actual emission amount of the vehicle is larger than a preset emission anomaly threshold, and determining whether a first duration during which the actual emission amount of the vehicle is larger than the preset emission anomaly threshold is longer than a first preset duration, wherein the preset emission anomaly threshold is obtained according to the current operating condition; in a case where the actual emission amount of the vehicle is larger than the preset emission anomaly threshold and the first duration is longer than the first preset duration, determining that the first detection result meets the preset condition for determining vehicle emission anomalies, and that the vehicle has an emission anomaly, and obtaining the cause and probability of the vehicle emission anomaly using the Cosine similarity calculation strategy, based on the preset vehicle emission anomaly knowledge graph database; otherwise, determining that the first detection result does not meet the preset condition for determining vehicle emission anomalies.

In an embodiment of the present invention, the first preset duration is set to 2 hours.

It should be understood that the current operating condition of the vehicle is determined based on the current operating data, and the preset emission anomaly threshold corresponding to the current operating condition is determined according to the mapping relationship. In a case where the actual emission amount of the vehicle is larger than the preset emission anomaly threshold corresponding to the current operating condition, and the first duration exceeds 2 hours, the first detection result is determined to meet the preset condition for determining vehicle emission anomalies, and it is directly determined that the vehicle has the emission anomaly. Furthermore, the cause and probability of the vehicle emission anomaly are obtained using the Cosine similarity calculation strategy, based on the preset vehicle emission anomaly knowledge graph database. Otherwise, the first detection result is determined not to meet the preset condition for determining vehicle emission anomalies, i.e., the first detection result alone cannot directly determine the vehicle emission anomaly, wherein the step of obtaining the cause and probability of the vehicle emission anomaly using the Cosine similarity calculation strategy, based on the preset vehicle emission anomaly knowledge graph database is described in detail below.

For example, in a case where the actual emission amount continuously exceeds the preset emission anomaly threshold corresponding to the current operating condition for 2 hours during the operation of the vehicle, integration with the second detection result for determination is not required, and it is directly determined that the vehicle has the emission anomaly.

Optionally, in some embodiments, the second detection result comprises the actual emission amount of the vehicle. After determining that the second detection result meets the preset condition for determining vehicle emission anomalies, the method comprises: determining whether a ratio of the actual emission amount of the vehicle to a predicted emission value is larger than a preset ratio and whether a second duration during which the actual emission amount of the vehicle is larger than the predicted emission value is longer than a second preset duration; in a case where the ratio of the actual emission amount of the vehicle to the predicted emission value is larger than the preset ratio and the second duration is longer than the second preset duration, determining that the second detection result meets the preset condition for determining vehicle emission anomalies, and that the vehicle has the emission anomaly, and obtaining the cause and probability of the vehicle emission anomaly using the Cosine similarity calculation strategy, based on the preset vehicle emission anomaly knowledge graph database; otherwise, determining that the second detection result does not meet the preset condition for determining vehicle emission anomalies.

In an embodiment of the present invention, the second preset duration is set to 2 hours, and the preset ratio is set to 1.5.

Specifically, the steps of constructing the preset emission prediction model and detecting whether the vehicle emission is abnormal are as follows.

In step 1, an LSTM machine learning model is trained and established using an LSTM neural network, with the obtained historical operating data as training data, the speed, acceleration, torque, engine speed, and fuel consumption rate of the vehicle from the historical operating data as inputs, and the NOx emission rate as the output, and the prediction of vehicle emissions is achieved.

In step 2, during the operation of the vehicle, the preset emission prediction model continuously predicts the predicted emission value, in a case where the ratio of the actual emission amount of the vehicle to the predicted emission value is larger than 1.5 for continuously 2 hours, then the second detection result is determined to meet the preset condition for determining vehicle emission anomalies, and a heavy-duty vehicle emission anomaly is directly determined without being integrated with the first detection result for determination; and the cause and probability of the vehicle emission anomaly are obtained using the Cosine similarity calculation strategy, based on the preset vehicle emission anomaly knowledge graph database; otherwise, the second detection result is determined not to meet the preset condition for determining vehicle emission anomalies, i.e., the second detection result cannot directly determine the vehicle emission anomaly.

In summary, the preset emission prediction model and the preset dynamic threshold model may independently determine whether a vehicle emission anomaly is present.

In step S103, when the first detection result and the second detection result fail to meet the preset condition for determining vehicle emission anomalies, the first detection result and the second detection result are integrated to obtain a final detection result, when the final detection result is higher than or equal to a preset threshold, the vehicle emission anomaly is determined, and the cause and probability of the vehicle emission anomaly are obtained using the Cosine similarity calculation strategy, based on the preset vehicle emission anomaly knowledge graph database.

It should be noted that the situation where the first detection result and the second detection result fail to meet the preset condition for determining vehicle emission anomalies may be understood as the case where the first detection result cannot directly determine the vehicle emission anomaly and the second detection result also cannot directly determine the vehicle emission anomaly, at the time, the first detection result and the second detection result are required to be integrated.

Optionally, in some embodiments, obtaining the final detection result by integrating the first detection result and the second detection result comprises: integrating the first detection result and the second detection result to obtain the final detection result using a preset integration formula, wherein the preset integration formula is as follows:

$$( \frac{{E}_{c a r}}{{E}_{T h}} \times a + \frac{{E}_{c a r}}{{E}_{P v}} \times b ) ; \qquad ( 1 )$$

wherein

$$( \frac{{E}_{car}}{{E}_{T h}} \times a + \frac{{E}_{car}}{{E}_{P v}} \times b )$$

is the final detection result, E_{car} is the actual emission amount of the vehicle, E_{Th} is the preset emission anomaly threshold, E_{Pv} is the predicted emission value, a is a weight of the first detection result, and b is a weight of the second detection result.

In the formula (1), parameter a is 0.6 by default, and parameter b is 0.4 by default. When the final detection result is higher than or equal to a preset threshold c, it is determined that the vehicle has an emission anomaly, thereby triggering emission anomaly traceability analysis. The preset threshold c needs to balance false alarm or missed alarm. Therefore, the preset threshold c is set to 1.2 by default, which can cover minor fluctuations while avoiding oversensitivity, thereby effectively preventing false alarm or missed alarm.

Specifically, in the embodiment of the present invention, a collaborative detection mechanism between the preset dynamic threshold model and the preset emission prediction model is established, so as to achieve accurate triggering of emission anomaly traceability analysis, comprising specific steps as follows.

In step 1, the preset dynamic threshold model and the preset emission prediction model are respectively used for detecting whether a vehicle emission anomaly is present, in a case where the vehicle emission anomaly is determined, emission anomaly traceability analysis is directly triggered;

when the first detection result and the second detection result fail to meet the preset condition for determining vehicle emission anomalies, integration of the first detection result output by the preset dynamic threshold model and the second detection result output by the preset emission prediction model is required; and

step 2, the first detection result output by the preset dynamic threshold model and the second detection result output by the preset emission prediction model are integrated using the preset integration formula, to obtain the final detection result.

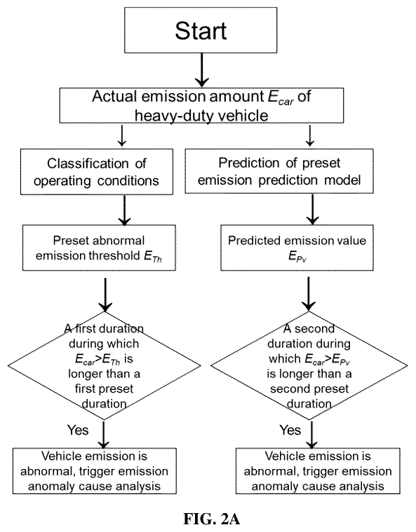

For example, as shown in FIG. 2A, in a case where the first duration during which the actual emission amount E_{car} of the vehicle is higher than the preset emission anomaly threshold E_{Th} is longer than the first preset duration, the vehicle emission anomaly is directly determined, and emission anomaly traceability analysis is directly triggered; otherwise, no emission anomaly is directly determined; in a case where the second duration during which the actual emission amount E_{car} of the vehicle is higher than the predicted emission value E_{Pv} is longer than the second duration, the vehicle emission anomaly is directly determined, and emission anomaly traceability analysis is directly triggered; otherwise, no emission anomaly is directly determined.

In a case where the actual emission amount is not the above two conditions, i.e., the first detection result and the second detection result fail to meet the preset condition for determining emission anomalies, no emission anomaly is determined based on the first and second detection results, then integration of the first detection result and the second detection result is required to obtain the final detection result, as shown in FIG. 2B. In a case where the final detection result

$$( \frac{{E}_{car}}{{E}_{T h}} \times a + \frac{{E}_{car}}{{E}_{P v}} \times b )$$

is higher than or equal to the preset threshold c, it is determined that the vehicle has the emission anomaly, and emission anomaly traceability analysis is directly triggered; and in a case where the final detection result is lower than the preset threshold c, no vehicle emission anomaly is determined.

Accordingly, the preset dynamic threshold model and the preset emission prediction model may independently detect whether the vehicle has the emission anomaly, or the respective detection results may also be integrated to determine whether the vehicle has the emission anomaly, then, the cooperative detection mechanism between the preset dynamic threshold model and the preset emission prediction model is established, which effectively and reliably supports the detection of heavy-duty vehicle emission anomalies, and avoids false alarm and missed alarm.

Optionally, in some embodiment, prior to obtaining the cause and probability of the vehicle emission anomalies using the Cosine similarity calculation strategy, based on the preset vehicle emission anomaly knowledge graph database, the method comprises: acquiring vehicle emission anomaly cause data; forming a vehicle emission anomaly cause data relationship chain based on the vehicle emission anomaly cause data; transforming the vehicle emission anomaly cause data relationship chain into entities and relationships in a knowledge graph using a preset knowledge graph theory; and performing entity integration on relatively conflicting entities using an entity alignment strategy so as to obtain the preset vehicle emission anomaly knowledge graph database.

Historical operating data of the vehicle is obtained via remote monitoring, and clustering analysis is performed using a K-Means clustering method to obtain multidimensional cluster centers, and each cluster center represents a relationship chain in the preset vehicle emission anomaly knowledge graph database.

Firstly, the historical operating data is obtained, comprising parameters such as vehicle speed, acceleration, net output torque of an engine, engine speed, engine fuel flow, engine coolant temperature, DPF differential pressure, DPF regeneration frequency, ambient temperature, intake pressure, exhaust temperature, exhaust back pressure, air-fuel ratio, exhaust gas recirculation (EGR) valve opening, urea injection quantity, particulate matter concentration, and the output value of an SCR downstream NOx sensor.

Next, the historical operating data is used as inputs, and clustering analysis is performed by the K-Means clustering method to obtain multidimensional cluster centers, and multidimensional features of each cluster center are extracted.

Finally, based on the multidimensional features of each cluster center, the cluster centers are associated with each relationship chain in the preset vehicle emission anomaly knowledge graph database, which supports cause-tracing of heavy-duty vehicle emission anomalies.

The steps of constructing the preset vehicle emission anomaly knowledge graph database based on the knowledge graph theory are as follows:
first, acquiring vehicle emission anomaly cause data via multiple channels and dimensions, wherein the data is specifically derived from: vehicle maintenance manuals, heavy-duty vehicle maintenance case data, operational and emission data collected by vehicle terminals of heavy-duty vehicles, and existing technical literature;
next, extracting a frequent association pattern between the root cause of an emission anomaly and the manifestation thereof from the vehicle emission anomaly cause data, and forming a vehicle emission anomaly cause relationship chain (for example, such a relationship chain may be expressed as: “urea pump blockage”→“reduction in urea injection quantity”→“decline in SCR catalytic efficiency”→“NOx exceeding the standard”);
then, transforming the vehicle emission anomaly cause relationship chain into two types: entities and relationships in the knowledge graph using the knowledge graph theory; and solving synonym and naming inconsistency issues in existing entities (for example, “SCR catalytic efficiency anomaly” and “SCR system catalytic rate decline” both denote the entity “SCR catalytic efficiency reduction”) using the entity alignment technique, based on expert knowledge; integrating relatively conflicting entities using the entity alignment technique, and achieving unification of knowledge representation in the knowledge graph; and
finally, storing the knowledge graph in the form of a graph database (such as Neo4j), thereby constructing the preset vehicle emission anomaly knowledge graph database, which supports efficient path querying and reasoning.

In addition, the preset vehicle emission anomaly knowledge graph database is dynamic and is continuously optimized with the accumulation and constant optimization of new cases and maintenance experience. The knowledge database may be continuously improved based on maintenance records, emission test results, etc., to enhance the accuracy of the knowledge database.

Optionally, in some embodiments, obtaining the cause and probability of the vehicle emission anomalies using the Cosine similarity calculation strategy, based on the preset vehicle emission anomaly knowledge graph database comprises: acquiring historical operating data of the vehicle; calculating data features of each relationship chain in the preset vehicle emission anomaly knowledge graph database using the Cosine similarity calculation strategy, based on the historical operating data, so as to obtain a plurality of Cosine similarity calculation results; and ranking the plurality of the Cosine similarity calculation results according to a preset ranking strategy, and taking the Cosine similarity calculation results meeting a preset ranking condition in the ranking results as the cause and probability of the vehicle emission anomaly.

Specifically, in the present invention, potential causes of vehicle emission anomalies and occurrence probabilities thereof are calculated using the Cosine similarity calculation strategy, based on the preset vehicle emission anomaly knowledge graph database, and multidimensional cause traceability analysis of the vehicle emission anomalies is achieved.

First, historical operating data of an emission anomaly is remotely extracted; and
next, the historical operating data of the emission anomaly and the data features of each relationship chain in the preset vehicle emission anomaly knowledge graph database are respectively calculated using the Cosine similarity calculation strategy, and a plurality of Cosine similarity calculation results are obtained.

The plurality of Cosine similarity calculation results are ranked based on the preset ranking strategy, and the Cosine similarity calculation results that meet the preset ranking condition are identified as the cause and probability of the vehicle emission anomaly. Specifically, in the embodiments of the present invention, each high-emission instance and each cause in the preset vehicle emission anomaly knowledge graph database are represented as vectors, and the Cosine similarity therebetween is calculated to measure the degree of similarity between the instance and each cause.

A similarity threshold (0.8) is set, and causes having similarity higher than 0.8 with the instance are regarded as specific potential causes resulting in high emissions. For each identified cause, the probability that the cause leads to high emissions is calculated using a weighted averaging method according to the similarity value. The higher the similarity, the higher the corresponding weight, indicating a higher contribution of the cause to high emissions.

Accordingly, ranking is performed based on the similarity of the relationship chains in the plurality of Cosine similarity calculation results, and the top three ranked relationship chains are taken as the potential causes of the vehicle emission anomaly, and the corresponding occurrence probability is obtained. Here, the “top three” may also be understood as the three relationship chains that are the most similar among the plurality of Cosine similarity calculation results.

The Cosine similarity calculation strategy specifically evaluates the similarity between two vectors by computing the cosine value of the angle therebetween. Given two non-zero vectors a and b, the Cosine similarity is defined as:

$$Cosine ( a , b ) = \frac{a \cdot b}{‖ a ‖ ‖ b ‖} .$$

wherein a·b represents a dot product of vectors a and b, ∥a∥ and ∥b∥ represent magnitudes of vectors a and b.

Optionally, in some embodiments, after determining that the vehicle has the emission anomaly, and obtaining the cause and probability of the vehicle emission anomaly using the Cosine similarity calculation strategy, based on the preset vehicle emission anomaly knowledge graph database, the method comprises: transmitting vehicle emission anomaly early warning information to a preset terminal; and generating vehicle maintenance recommendations using an AI model based on the vehicle emission anomaly early warning information and the cause and probability of the vehicle emission anomaly.

Specifically, the vehicle emission anomaly early warning information is sent to the preset terminal to alert a user or vehicle monitoring personnel of the emission anomaly. The potential causes of the vehicle emission anomaly and the occurrence probability thereof are visualized, and vehicle maintenance recommendations are simultaneously generated using AI large models such as DeepSeek or ChatGPT, which support both PC and mobile terminal viewing.

In summary, dynamic, multidimensional cause traceability analysis of heavy-duty vehicle emission anomalies can be achieved.

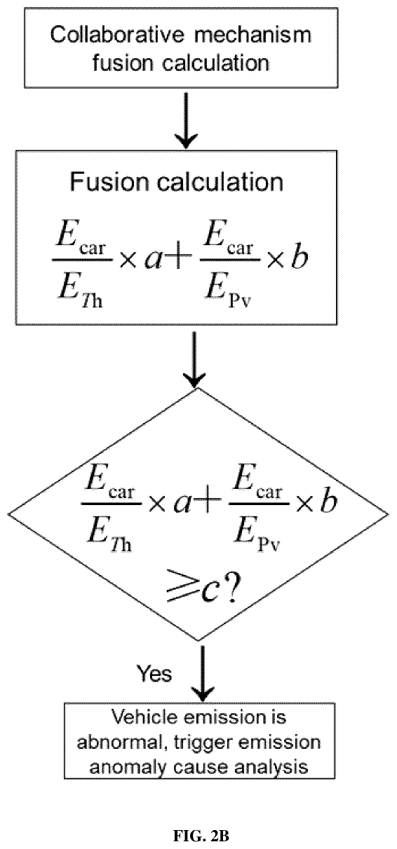

To allow those skilled in the art to further understand the method for detecting and tracing vehicle emission anomalies provided by the embodiment of the present invention, a detailed description is provided below with reference to specific embodiments, as shown in FIG. 3.

1. Collection of multi-source data and extraction of association patterns to form relationship chains.

First, vehicle emission anomaly cause data is acquired via multiple channels and dimensions, wherein the data is specifically derived from: vehicle maintenance manuals, heavy-duty vehicle maintenance case data, operational and emission data collected by vehicle terminals of heavy-duty vehicles, and existing technical literature.

Regarding automobile maintenance manuals, all information concerning the causes of vehicle emission anomalies was obtained from the Heavy-Duty Truck Maintenance Technical Manual; regarding heavy-duty vehicle maintenance case data, maintenance case data for heavy-duty vehicles in a certain region over the past three years was investigated; regarding operational and emission data collected by vehicle terminals of heavy-duty vehicles, 500 heavy-duty vehicles, each with a cumulative mileage exceeding 50,000 kilometers, were selected, and all OBD diagnostic fault information generated since the production of the vehicles was downloaded. Regarding prior art literature, multiple academic papers studying heavy-duty vehicle emission anomalies were queried and downloaded.

A frequent association pattern between the root cause of an emission anomaly and the manifestation thereof is extracted from the vehicle emission anomaly cause data, and a vehicle emission anomaly cause relationship chain (for example, such a relationship chain may be expressed as: “urea pump blockage”→“reduction in urea injection quantity”→“decline in SCR catalytic efficiency”→“NOx exceeding the standard”) is formed.

2. Construction and optimization of the knowledge graph, and storage of the same in a graph database to form a dynamic knowledge graph database.

The vehicle emission anomaly cause relationship chains are transformed into two types: entities and relationships in the knowledge graph using the knowledge graph theory. Synonym and naming inconsistency issues in existing entities (for example, “SCR catalytic efficiency anomaly” and “SCR system catalytic rate decline” both denote the entity “SCR catalytic efficiency reduction”) using the entity alignment technique are solved based on expert knowledge. Relatively conflicting entities are integrated using the entity alignment technique, and unification of knowledge representation in the knowledge graph is achieved.

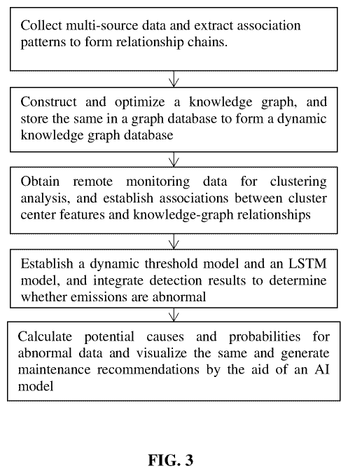

Finally, the above knowledge graph is stored in the form of a graph database (such as Neo4j), and thus the preset vehicle emission anomaly knowledge graph database is constructed, which supports efficient path querying and reasoning, and the completed vehicle emission anomaly cause knowledge graph is constructed, as shown in FIG. 4.

3. Acquisition of remote monitoring data for clustering analysis, and establishment of associations between cluster center features and knowledge-graph relationships.

For example, historical operating data of the vehicle over one month is remotely obtained from 500 heavy-duty vehicles exhibiting emission anomalies, the cumulative mileages of all the vehicles exceed 50,000 kilometers, and clustering analysis is performed using the K-Means clustering method to obtain multidimensional cluster centers, wherein each cluster center represents a relationship chain in the preset vehicle emission anomaly knowledge graph database.

Firstly, heavy-duty vehicle remote monitoring data with sampling frequency of 1 Hz is obtained, comprising parameters such as vehicle speed, acceleration, net output torque of an engine, engine speed, engine fuel flow, engine coolant temperature, DPF differential pressure, DPF regeneration frequency, ambient temperature, intake pressure, exhaust temperature, exhaust back pressure, air-fuel ratio, exhaust gas recirculation (EGR) valve opening, urea injection quantity, particulate matter concentration, and the output value of an SCR downstream NOx sensor.

Next, the heavy-duty vehicle remote monitoring data is used as input, and clustering analysis is performed using the K-Means clustering method to obtain multidimensional cluster centers, and multidimensional features of each cluster center are extracted (for example: “vehicle speed v<25 km/h; acceleration a ≥0.32 m/s²”→“low-speed acceleration condition”→“NOx exceeding the standard”; “vehicle speed v≥50 km/h; acceleration a≤−0.68 m/s²”→“high-speed deceleration condition”≥“NOx exceeding the standard”).

Finally, based on the multidimensional features of each cluster center, the cluster centers are associated with each relationship chain in the preset vehicle emission anomaly knowledge graph database, which supports cause-tracing of heavy-duty vehicle emission anomalies.

4. Establishment of a dynamic threshold model and an LSTM model, and integration of detection results to determine whether emissions are abnormal.

First, constructing a preset dynamic threshold model to detect whether heavy-duty vehicle emissions are abnormal, specifically comprises:
step 1, establishing four categories of preset operating conditions: urban/suburban condition (vehicle speed lower than 50 km/h and idling ratio higher than 18%), highway cruising condition (vehicle speed higher than 70 km/h and throttle opening fluctuation rate lower than 10%), climbing condition (engine torque higher than 70% and road gradient greater than 6%), and low-temperature cold start condition (coolant temperature lower than 40 °C and ambient temperature lower than 10 °C);
step 2, processing the obtained heavy-duty vehicle remote monitoring data using a 30-second moving window average method, classifying the data into the urban/suburban condition, highway cruising condition, climbing condition, and low-temperature cold start condition according to data features, and calculating a 95th percentile of NOx emissions under each operating condition as the emission anomaly threshold, and establishing the mapping relationship between the preset operating condition and the corresponding emission anomaly threshold; and
step 3, determining the corresponding preset emission anomaly threshold based on the current operating condition, in a case where the emission continuously exceeds the preset emission anomaly threshold corresponding to the current operating condition for 2 hours during the operation of the heavy-duty vehicle, the first detection result meeting the preset condition for determining vehicle emission anomalies, directly determining that the heavy-duty vehicle has the emission anomaly, and directly triggering emission anomaly traceability analysis.

Then, constructing the preset emission prediction model (LSTM model) and detecting whether the vehicle emission is abnormal comprises:
step 1, an LSTM machine learning model is trained and created using an LSTM neural network, with the remotely obtained historical data of the heavy-duty vehicle as training data, the speed, acceleration, torque, engine speed, and fuel consumption rate from the data as inputs, and the NOx emission rate as the output, and the prediction of heavy-duty vehicle emissions is achieved; and
step 2, in a case where the emission continuously exceeds 1.5 times the predicted value output by the preset emission prediction model for 2 hours during the operation of the heavy-duty vehicle, the second detection result meets the preset condition for determining vehicle emission anomalies, it is directly determined that the heavy-duty vehicle has the emission anomaly, and emission anomaly traceability analysis is directly triggered.

Finally, a collaborative detection mechanism between the preset dynamic threshold model and the preset emission prediction model is constructed, so as to achieve accurate triggering of emission anomaly traceability analysis, specifically comprising:
step 1, using the first detection result obtained by detecting with the preset dynamic threshold model and the second detection result obtained by detecting with the preset emission prediction model; and
step 2, in a case where the first detection result and the second detection result fail to meet the preset condition for determining vehicle emission anomalies, integrating the first detection result output by the preset dynamic threshold model and the second detection result output by the preset emission prediction model to obtain a final detection result.

5. Calculation of potential causes and probabilities for abnormal data and visualization of the same, and generation of maintenance recommendations using an AI model.

Potential causes of heavy-duty vehicle emission anomalies and occurrence probabilities thereof are calculated using the Cosine similarity calculation strategy, based on the preset vehicle emission anomaly knowledge graph database, and multidimensional cause traceability analysis of heavy-duty vehicle emission anomalies is achieved.

A 25-ton heavy-duty vehicle of a certain model with a known emission anomaly is taken as an example, and the present invention used for multidimensional cause traceability analysis. First, the current operating data of the remotely monitored target heavy-duty vehicle is extracted, with a data sampling frequency of 1 Hz, the data comprises the vehicle VIN, collection time, vehicle speed, atmospheric pressure, engine net output torque, engine speed, engine fuel flow rate, etc., and the data is preprocessed by removing null values and anomaly values whose feature values fall outside acceptable ranges.

Next, the remote monitoring data of the heavy-duty vehicle with the emission anomaly and the data features of each relationship chain in the preset vehicle emission anomaly knowledge graph database are respectively calculated using the Cosine similarity calculation strategy, and Cosine similarity calculation results are obtained. The top three ranked relationship chains are taken as the potential causes of the emission anomaly of the heavy-duty vehicle, and the occurrence probability of the corresponding potential causes is obtained. Here, the “top three” may also be understood as the three relationship chains that are the most similar in results.

Finally, the potential causes of the emission anomaly of the heavy-duty vehicle and the occurrence probability thereof are visualized, and vehicle maintenance recommendations are simultaneously generated using AI large models such as DeepSeek or ChatGPT, which support both PC and mobile terminal viewing, and the visualized results are output, as shown in Table 1.

TABLE 1

| Serial | Causes of | | |
|---|---|---|---|
| Number | Faults | Probability | Maintenance Recommendation |
| 1 | EGR blockage | 65.3% | Clean an EGR valve and check |
| | | | sealing |
| 2 | SCR sulfur | 31.9% | Clean a SCR system and check |
| | poisoning | | a urea injection apparatus |
| 3 | DPF | 2.8% | Force DPF regeneration, clean |
| | regeneration | | or replace the DPF |
| | failure | | |

In summary, the embodiment of the present invention has the following beneficial effects:
(1) the collaborative detection mechanism integrating the dynamic threshold model and the LSTM time-series prediction model is established, the false alarm rate and the missed alarm rate in detection of heavy-duty vehicle emission anomalies are substantially reduced by weighted collaboration, and the accuracy and stability of anomaly identification are ensured;
(2) modeling is performed based on the relationship chain in the emission anomaly knowledge-graph database constructed by the Neo4j graph database, potential fault paths are rapidly matched in combination with Cosine similarity, the traceability time is shortened, the accuracy is improved, and the dynamic updating mechanism is supported, so that maintenance cases and real-time data are continuously incorporated to enhance the practicability of the knowledge database; and
(3) a plurality of parameters of vehicles are remotely monitored, the system can trigger anomaly early warnings and traceability analysis within a short period, maintenance recommendations are automatically generated by integration with the AI large model, and the results are pushed in real time via a visual interface.

According to the method for detecting and tracing the vehicle emission anomaly provided in the embodiments of the present invention, the current operating condition and the current operating data are input into the preset dynamic threshold model to obtain the first detection result, and the current operating condition and the current operating data are input into the preset emission prediction model to obtain the second detection result, wherein the preset dynamic threshold model is constructed based on the plurality of preset operating conditions and the corresponding preset emission anomaly threshold for each preset operating condition, and the preset emission prediction model is obtained by training the LSTM neural network using the historical operating data of the vehicle; when the first detection result and the second detection result fail to meet the preset condition for determining vehicle emission anomalies, the first detection result and the second detection result are integrated to obtain the final detection result, when the final detection result is higher than or equal to the preset threshold, it is determined that the vehicle has the emission anomaly, and the cause and probability of the vehicle emission anomaly are obtained using the Cosine similarity calculation strategy, based on the vehicle emission anomaly knowledge graph database. Accordingly, the problems of low detection efficiency, high misjudgment rate, and difficulty in tracing of emission anomalies due to data fragmentation and complex causal relationships in traditional methods for detecting and tracing vehicle emission anomalies are solved, and accurate detection of the emission anomalies is achieved.

Then, an apparatus for detecting and tracing vehicle emission anomalies is described with reference to the drawings.

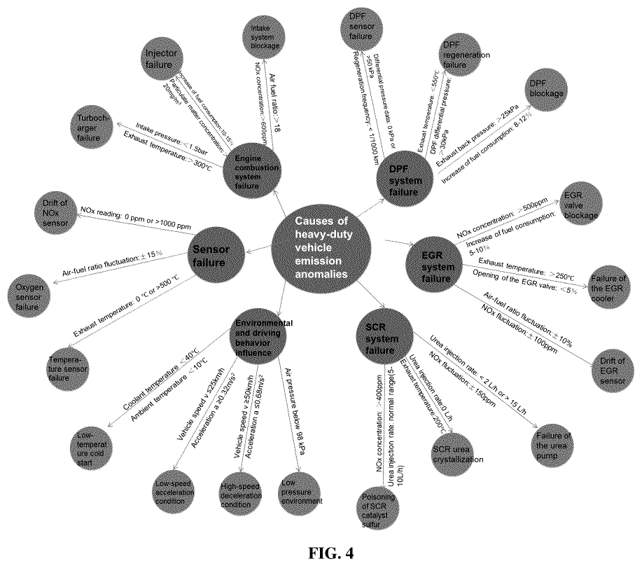

FIG. 5 is a block diagram of an apparatus for detecting and tracing vehicle emission anomalies according to an embodiment of the present invention.

As shown in FIG. 5, the apparatus for detecting and tracing vehicle emission anomalies 10 comprises: an acquisition module 100, a detection module 200, and a tracing module 300,
wherein the acquisition module 100 is configured to acquire a current operating condition and current operating data; the detection module 200 is configured to input the current operating condition and the current operating data into a preset dynamic threshold model to obtain a first detection result, and input the same into a preset emission prediction model to obtain a second detection result, wherein the preset dynamic threshold model is constructed based on a plurality of preset operating conditions and a corresponding preset emission anomaly threshold for each preset operating condition, and the preset emission prediction model is obtained by training an LSTM neural network using historical operating data of the vehicle; and the tracing module 300 is configured to integrate the first detection result and the second detection result to obtain a final detection result when the first detection result and the second detection result fail to meet a preset condition for determining vehicle emission anomalies, and determine that the vehicle has an emission anomaly when the final detection result is higher than or equal to a preset threshold, and obtain a cause and probability of the vehicle emission anomaly using a Cosine similarity calculation strategy based on a preset vehicle emission anomaly knowledge graph database.

Optionally, in some embodiments, the first detection result comprises an actual emission amount of the vehicle, and in determining whether the first detection result meets the preset condition for determining vehicle emission anomalies, the detection module 200 is further configured to: determine whether the actual emission amount of the vehicle is larger than a preset emission anomaly threshold, and determine whether a first duration during which the actual emission amount of the vehicle is larger than the preset emission anomaly threshold is longer than a first preset duration, wherein the preset emission anomaly threshold is obtained according to the current operating condition; determine that the first detection result meets the preset condition for determining vehicle emission anomalies, in a case where the actual emission amount of the vehicle is larger than the preset emission anomaly threshold and the first duration is longer than the first preset duration, determine that the vehicle has the emission anomaly, and obtain the cause and probability of the vehicle emission anomalies using the Cosine similarity calculation strategy, based on the preset vehicle emission anomaly knowledge graph database; otherwise, determine that the first detection result does not meet the preset condition for determining vehicle emission anomalies.

Optionally, in some embodiments, prior to determining whether the first detection result is higher than the preset emission anomaly threshold, the detection module 200 is further configured to: acquire historical operating data of the vehicle; construct the plurality of preset operating conditions according to data features in the historical operating data; and establish a mapping relationship between the historical operating data of each preset operating condition and the emission anomaly threshold, so as to obtain the preset emission anomaly threshold according to the current operating condition based on the mapping relationship.

Optionally, in some embodiments, the second detection result comprises an actual emission amount of the vehicle, after determining that the second detection result meets the preset condition for determining vehicle emission anomalies, the detection module 200 is further configured to: determine whether a ratio of the actual emission amount of the vehicle to the predicted emission value is larger than a preset ratio and whether a second duration during which the actual emission amount of the vehicle is larger than the emission prediction value is longer than a second preset duration; determine that the second detection result meets the preset condition for determining vehicle emission anomalies, in a case where the ratio of the actual emission amount of the vehicle to a predicted emission value is larger than the preset ratio and the second duration is longer than the second preset duration, determine that the vehicle has the emission anomaly, and obtain the cause and probability of the vehicle emission anomaly using the Cosine similarity calculation strategy, based on the preset vehicle emission anomaly knowledge graph database; otherwise, determine that the second detection result does not meet the preset condition for determining vehicle emission anomalies.

Optionally, in some embodiments, the tracing module 300 is further configured to: acquire historical operating data of the vehicle; calculate data features of each relationship chain in the preset vehicle emission anomaly knowledge graph database using the Cosine similarity calculation strategy, based on the historical operating data, so as to obtain a plurality of Cosine similarity calculation results; and ranking the plurality of the Cosine similarity calculation results according to a preset ranking strategy, and taking the Cosine similarity calculation results meeting a preset ranking condition in the ranking results as the cause and probability of the vehicle emission anomaly.

Optionally, in some embodiments, prior to obtaining the cause and probability of the vehicle emission anomaly using the Cosine similarity calculation strategy, based on the preset vehicle emission anomaly knowledge graph database, the tracing module 300 is further configured to: acquire vehicle emission anomaly cause data; form a vehicle emission anomaly cause data relationship chain based on the vehicle emission anomaly cause data; transform the vehicle emission anomaly cause data relationship chain into entities and relationships in a knowledge graph using a preset knowledge graph theory; and perform entity integration on relatively conflicting entities using an entity alignment strategy so as to obtain the preset vehicle emission anomaly knowledge graph database.

Optionally, in some embodiments, the tracing module 300 is further configured to: integrate the first detection result and the second detection result using a preset integration formula to obtain the final detection result, wherein the preset integration formula is as follows:

$$( \frac{{E}_{c a r}}{{E}_{T h}} \times a + \frac{{E}_{c a r}}{{E}_{P v}} \times b ) ;$$

wherein

$$( \frac{{E}_{car}}{{E}_{T h}} \times a + \frac{{E}_{car}}{{E}_{P v}} \times b )$$

is the final detection result, E_{car} is the actual emission amount of the vehicle, E_{Th} is the preset emission anomaly threshold, E_{Pv} is the predicted emission value, a is a weight of the first detection result, and b is a weight of the second detection result.

Optionally, in some embodiments, after determining that the vehicle has the emission anomaly, and obtaining the cause and probability of the vehicle emission anomaly using the Cosine similarity calculation strategy, based on the preset vehicle emission anomaly knowledge graph database, the tracing module 300 is further configured to: transmit vehicle emission anomaly early warning information to a preset terminal; and generate vehicle maintenance recommendations using an AI model based on the vehicle emission anomaly early warning information and the cause and probability of the vehicle emission anomaly.

It should be noted that the previous explanations and descriptions of the embodiments of the method for detecting and tracing vehicle emission anomalies are also applicable to the apparatus for detecting and tracing vehicle emission anomalies of the embodiment, and will not be reiterated here.

According to the apparatus for detecting and tracing vehicle emission anomalies provided in the embodiment of the present invention, the current operating condition and the current operating data are input into the preset dynamic threshold model to obtain the first detection result, and the current operating condition and the current operating data are input into the preset emission prediction model to obtain the second detection result, wherein the preset dynamic threshold model is constructed based on the plurality of preset operating conditions and the corresponding preset emission anomaly threshold for each preset operating condition, and the preset emission prediction model is obtained by training the LSTM neural network using the historical operating data of the vehicle; when the first detection result and the second detection result fail to meet the preset condition for determining vehicle emission anomalies, the first detection result and the second detection result are integrated to obtain the final detection result, when the final detection result is higher than or equal to the preset threshold, it is determined that the vehicle has the emission anomaly, and the cause and probability of the vehicle emission anomaly are obtained using the Cosine similarity calculation strategy, based on the vehicle emission anomaly knowledge graph database. Accordingly, the problems of low detection efficiency, high misjudgment rate, and difficulty in tracing of emission anomalies due to data fragmentation and complex causal relationships in traditional methods for detecting and tracing vehicle emission anomalies are solved, accurate detection of the emission anomalies is achieved, closed-loop management from anomaly triggering to root cause tracing is completed, and the purposes of reducing vehicle emission pollution, improving the level of intelligent operation and maintenance, and ensuring environmental protection compliance are achieved.

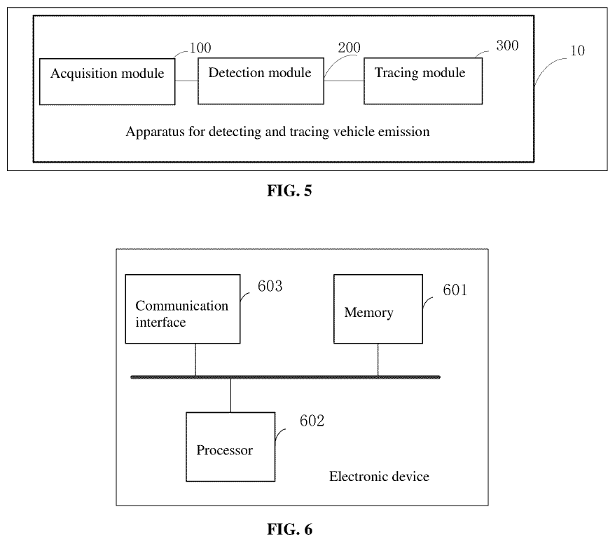

FIG. 6 is a structural schematic diagram of an electronic device according to an embodiment of the present invention. The electronic device may comprise:
a memory 601, a processor 602, and a computer program stored in the memory 601 and capable of running on the processor 602.

The processor 602 implements the method for detecting and tracing vehicle emission anomalies provided according to the above embodiment when executing the program.

Further, the electronic device further comprises:
a communication interface 603, configured to perform communication between the memory 601 and the processor 602.

The memory 601 is configured to store the computer program capable of running on the processor 602.

The memory 601 may comprise a high-speed RAM memory, and may also comprise a non-volatile memory, such as at least one disk memory.

In a case where the memory 601, the processor 602, and the communication interface 603 are implemented separately, the communication interface 603, the memory 601, and the processor 602 may be connected via a bus to enable mutual communication. The bus may be an Industry Standard Architecture (ISA) bus, a Peripheral Component Interconnect (PCI) bus oran Extended Industry Standard Architecture (EISA) bus, etc. The bus may be divided into an address bus, a data bus, a control bus, etc. For ease of illustration, only a single thick line is shown in FIG. 6, which does not imply that only one bus or one type of bus is present.

Optionally, in specific implementation, in a case where the memory 601, the processor 602, and the communication interface 603 are integrated in a single chip, communication among the memory 601, the processor 602, and the communication interface 603 can be achieved via internal interfaces.

The processor 602 may be a Central Processing Unit (CPU), an Application Specific Integrated Circuit (ASIC), or one or more integrated circuits configured to implement the embodiments of the present invention.

An embodiment of the present invention provides a computer program product, in which a computer program is stored, and the program implements the above method for detecting and tracing vehicle emission anomalies when executed by a processor.

In the description of the specification, the description of reference terms “one embodiment”, “some embodiments”, “examples”, “specific examples”, or “some examples”, etc. means that the specific features, structures, materials or characteristics described in conjunction with the embodiments or examples are comprised in at least one embodiment or example of the present invention. In the specification, the schematic expression of the above-mentioned terms is not necessarily referring to the same embodiment or example. Moreover, the described specific features, structures, materials or characteristics may be combined in any one or more embodiments or examples in a suitable manner. In addition, under the condition of no mutual contradiction, those skilled in the art can incorporate and combine different embodiments or examples described in the specification and the features of different embodiments or examples.

In addition, the terms “first” and “second” are only intended for description, and shall not be understood as indication or implication of relative importance or implicit indication of the number of indicated technical features. Therefore, the features defined with “first” and “second” may explicitly or implicitly comprise at least one of the features. In the description of the present invention, “N” means at least two, for example, two, three, etc., unless otherwise specifically defined.

Any process or method described in the flowcharts or otherwise herein may be understood as a module, segment, or portion of code comprising executable instructions that implement one or N steps for achieving customized logical functions or processes, and the scope of the preferred implementations of the present invention comprises alternative implementations, in which the function is not executed necessarily in the order shown or discussed, comprising in a substantially simultaneous manner or in the reverse order, according to the function involved. Such variations should be understood by those skilled in the art to which the embodiments of the present invention pertain.

Logic and/or steps shown in the flowchart or described in other ways here, e.g., an ordered list of executable instructions that can be considered to implement logical functions, may be specifically implemented in any computer program product for use by or in connection with instruction executing systems, apparatuses or devices (such as computer-based systems, systems comprising processors or other systems capable of receiving instructions from the instruction executing systems, apparatuses or devices and executing the instructions). In terms of the specification, “the computer program product” may be any apparatus which may contain, store, communicate, propagate or transport programs for use by or in connection with the instruction executing systems, apparatuses or devices. More specific examples (non-exhaustive list) of the computer program product comprise an electric connection part (electronic apparatus) with one or N wires, a portable computer disk cartridge (magnetic apparatus), a read-access memory (RAM), a read-only memory (ROM), an erasable programmable read-only memory (EPROM or flash memory), an optical fiber apparatus and a portable compact disk read-only memory (CDROM). Additionally, the computer program product may even be paper or other suitable media on which programs may be printed, as the program can be electronically captured, via for example, optical scanning of the paper or other medium, then compiled, interpreted or otherwise processed in a suitable manner if necessary, and then stored in a computer memory.

It should be understood that each part of the present invention may be implemented by hardware, software, firmware or a combination thereof. In the above implementations, N steps or methods may be implemented by software or firmware stored in a memory and executed by an appropriate instruction execution system. For example, in a case where the steps or methods are implemented by the hardware, as what are implemented in another implementation, the steps or methods may be implemented by any one or a combination of the following technologies known in the art: a discrete logic circuit with a logic gate circuit used for implementing a logic function on data signals, an application-specific integrated circuit with an appropriate combinational logic circuit, a programmable gate array (PGA), a field programmable gate array (FPGA), etc.

Those ordinarily skilled in the art can understand that all or part of steps in the methods of the embodiments may be implemented by relevant hardware instructed by programs. The programs may be stored in a computer program. The program comprises one or a combination of the steps of the methods of the embodiments.

In addition, each function unit in each embodiment of the present invention may be integrated into one processing unit, or each unit is separate physically, or two or more units may be integrated in one module. The above integrated units may be implemented in the form of hardware or software function modules. When implemented in the form of software function modules and sold or used as independent products, the integrated modules may be stored in the computer program product.

The above computer program product may be a read-only memory, a magnetic disk or an optical disk, etc. Although the embodiments of the present invention have been shown and described above, it is understandable that the above embodiments are illustrative and cannot be understood as restrictions on the present invention. Those ordinarily skilled in the art can change, modify, replace and alternate the above embodiments within the scope of the present invention.

1. A method for detecting and tracing vehicle emission anomalies, comprising:
acquiring a current operating condition and current operating data of a vehicle;
inputting the same into a preset dynamic threshold model to obtain a first detection result, and inputting the same into a preset emission prediction model to obtain a second detection result, wherein the preset dynamic threshold model is constructed based on a plurality of preset operating conditions and a preset emission anomaly threshold corresponding to each preset operating condition, and the preset emission prediction model is obtained by training a long short-term memory neural network using historical operating data of the vehicle;
when the first detection result and the second detection result fail to meet a preset condition for determining vehicle emission anomalies, integrating the first detection result and the second detection result to obtain a final detection result; when the final detection result is higher than or equal to a preset threshold, determining that the vehicle has an emission anomaly, and obtaining a cause and probability of the vehicle emission anomaly using a Cosine similarity calculation strategy, based on a preset vehicle emission anomaly knowledge graph database;
the integrating the first detection result and the second detection result using a preset integration formula to obtain the final detection result, wherein the preset integration formula is as follows:
$$( \frac{{E}_{c a r}}{{E}_{T h}} \times a + \frac{{E}_{c a r}}{{E}_{P v}} \times b ) ;$$
wherein
$$( \frac{{E}_{c a r}}{{E}_{T h}} \times a + \frac{{E}_{c a r}}{{E}_{P v}} \times b )$$
is the final detection result, E_{car} is the actual emission amount of the vehicle, E_{Th} is the preset emission anomaly threshold, E_{Pv} is the predicted emission value, a is a weight of the first detection result, and bb is a weight of the second detection result.

2. The method for detecting and tracing vehicle emission anomalies according to claim 1, wherein the first detection result comprises an actual emission amount of the vehicle, and determining whether the first detection result meets the preset condition for determining vehicle emission anomalies further comprises:
determining whether the actual emission amount of the vehicle is larger than a preset emission anomaly threshold, and determining whether a first duration during which the actual emission amount of the vehicle is larger than the preset emission anomaly threshold is longer than a first preset duration, wherein the preset emission anomaly threshold is obtained according to the current operating condition;
in a case where the actual emission amount of the vehicle is larger than the preset emission anomaly threshold and the first duration is longer than the first preset duration, determining that the first detection result meets the preset condition for determining vehicle emission anomalies, and that the vehicle has the emission anomaly, and the cause and probability of the vehicle emission anomaly are obtained using the Cosine similarity calculation strategy, based on the preset vehicle emission anomaly knowledge graph database; otherwise, determining that the first detection result does not meet the preset condition for determining vehicle emission anomalies.

3. The method for detecting and tracing vehicle emission anomalies according to claim 2, wherein prior to determining whether the first detection result is higher than the preset emission anomaly threshold, the method further comprises:
acquiring historical operating data of the vehicle;
constructing the plurality of preset operating conditions according to data features in the historical operating data; and
establishing a mapping relationship between the historical operating data of each preset operating condition and the emission anomaly threshold, so as to obtain the preset emission anomaly threshold according to the current operating condition based on the mapping relationship.

4. The method for detecting and tracing vehicle emission anomalies according to claim 1, wherein the second detection result comprises the actual emission amount of the vehicle, and during determining whether the second detection result satisfy the preset emission anomaly threshold, the method further comprises:
determining whether a ratio of the actual emission amount of the vehicle to a predicted emission value is larger than a preset ratio and whether second duration during which the actual emission amount of the vehicle is larger than the predicted emission value is longer than a second preset duration;
in a case where the ratio of the actual emission amount of the vehicle to the predicted emission value is larger than the preset ratio and the second duration is longer than the second preset duration, determining that the second detection result meets the preset condition for determining vehicle emission anomalies, and that the vehicle has the emission anomaly, and obtaining the cause and probability of the vehicle emission anomaly using the Cosine similarity calculation strategy, based on the preset vehicle emission anomaly knowledge graph database; otherwise, determining that the second detection result does not meet the preset condition for determining vehicle emission anomalies.

5. The method for detecting and tracing vehicle emission anomalies according to claim 1, wherein the obtaining the cause and probability of the vehicle emission anomalies using the Cosine similarity calculation strategy, based on the preset vehicle emission anomaly knowledge graph database comprises:
acquiring historical operating data of the vehicle;
calculating data features of each relationship chain in the preset vehicle emission anomaly knowledge graph database using the Cosine similarity calculation strategy, based on the historical operating data, so as to obtain a plurality of Cosine similarity calculation results; ranking the plurality of Cosine similarity calculation results according to a preset ranking strategy, and taking the Cosine similarity calculation results meeting a preset ranking condition in the ranking results as the cause and probability of the vehicle emission anomaly.

6. The method for detecting and tracing vehicle emission anomalies according to claim 5, wherein prior to obtaining the cause and probability of the vehicle emission anomaly using the Cosine similarity calculation strategy, based on the preset vehicle emission anomaly knowledge graph database, the method comprises:
acquiring vehicle emission anomaly cause data;
forming a vehicle emission anomaly cause data relationship chain based on the vehicle emission anomaly cause data;
transforming the vehicle emission anomaly cause data relationship chain into entities and relationships in a knowledge graph using a preset knowledge graph theory; and
performing entity integration on relatively conflicting entities using an entity alignment strategy so as to obtain the preset vehicle emission anomaly knowledge graph database.

7. (canceled)

8. The method for detecting and tracing vehicle emission anomalies according to claim 1, wherein after determining that the vehicle has the emission anomaly, and the cause and probability of the vehicle emission anomaly are obtained using the Cosine similarity calculation strategy, based on the preset vehicle emission anomaly knowledge graph database, the method comprises:
transmitting vehicle emission anomaly early warning information to a preset terminal; and
generating vehicle maintenance recommendations using an AI model based on the vehicle emission anomaly early warning information and the cause and probability of the vehicle emission anomaly.

9. An apparatus for detecting and tracing vehicle emission anomalies, comprising:
an acquisition module, configured to acquire a current operating condition and current operating data of a vehicle;
a detection module, configured to input the current operating condition and current operating data into a preset dynamic threshold model to obtain a first detection result, and input the same into a preset emission prediction model to obtain a second detection result, wherein the preset dynamic threshold model is constructed based on a plurality of preset operating conditions and a preset emission anomaly threshold corresponding to each preset operating condition, and the preset emission prediction model is obtained by training a long short-term memory neural network using historical operating data of the vehicle; and
a tracing module, configured to integrate the first detection result and the second detection result to obtain a final detection result when the first detection result and the second detection result fail to meet a preset condition for determining vehicle emission anomalies, determine that the vehicle has an emission anomaly when the final detection result is higher than or equal to a preset threshold, and obtain a cause and probability of the vehicle emission anomaly using a Cosine similarity calculation strategy, based on a preset vehicle emission anomaly knowledge graph database;
wherein the tracing module, further configured to integrate the first detection result and the second detection result by using a preset integration formula to obtain the final detection result comprises, wherein the preset integration formula is as follows:
$$( \frac{{E}_{c a r}}{{E}_{T h}} \times a + \frac{{E}_{c a r}}{{E}_{P v}} \times b ) ;$$
wherein
$$( \frac{{E}_{c a r}}{{E}_{T h}} \times a + \frac{{E}_{c a r}}{{E}_{P v}} \times b )$$
is the final detection result, E_{car} is the actual emission amount of the vehicle, E_{Th} is the preset emission anomaly threshold, E_{Pv} is the predicted emission value, a is a weight of the first detection result, and b is a weight of the second detection result.

10. An electronic device, comprising a memory, a processor, and a computer program stored in the memory and capable of running on the processor, and the processor implements the computer program to implement the method for detecting and tracing the vehicle emission anomalies according to claim 1.

11. The electronic device of claim 10, wherein the first detection result comprises an actual emission amount of the vehicle, and determining whether the first detection result meets the preset condition for determining vehicle emission anomalies further comprises:
determining whether the actual emission amount of the vehicle is larger than a preset emission anomaly threshold, and determining whether a first duration during which the actual emission amount of the vehicle is larger than the preset emission anomaly threshold is longer than a first preset duration, wherein the preset emission anomaly threshold is obtained according to the current operating condition;
in a case where the actual emission amount of the vehicle is larger than the preset emission anomaly threshold and the first duration is longer than the first preset duration, determining that the first detection result meets the preset condition for determining vehicle emission anomalies, and that the vehicle has the emission anomaly, and the cause and probability of the vehicle emission anomaly are obtained using the Cosine similarity calculation strategy, based on the preset vehicle emission anomaly knowledge graph database; otherwise, determining that the first detection result does not meet the preset condition for determining vehicle emission anomalies.

12. The electronic device of claim 11, wherein prior to determining whether the first detection result is higher than the preset emission anomaly threshold, the method further comprises:
acquiring historical operating data of the vehicle;
constructing the plurality of preset operating conditions according to data features in the historical operating data; and
establishing a mapping relationship between the historical operating data of each preset operating condition and the emission anomaly threshold, so as to obtain the preset emission anomaly threshold according to the current operating condition based on the mapping relationship.

13. The electronic device of claim 10, wherein the second detection result comprises the actual emission amount of the vehicle, and during determining whether the second detection result satisfy the preset emission anomaly threshold, the method further comprises:
determining whether a ratio of the actual emission amount of the vehicle to a predicted emission value is larger than a preset ratio and whether second duration during which the actual emission amount of the vehicle is larger than the predicted emission value is longer than a second preset duration;
in a case where the ratio of the actual emission amount of the vehicle to the predicted emission value is larger than the preset ratio and the second duration is longer than the second preset duration, determining that the second detection result meets the preset condition for determining vehicle emission anomalies, and that the vehicle has the emission anomaly, and obtaining the cause and probability of the vehicle emission anomaly using the Cosine similarity calculation strategy, based on the preset vehicle emission anomaly knowledge graph database; otherwise, determining that the second detection result does not meet the preset condition for determining vehicle emission anomalies.

14. The electronic device of claim 10, wherein the obtaining the cause and probability of the vehicle emission anomalies using the Cosine similarity calculation strategy, based on the preset vehicle emission anomaly knowledge graph database comprises:
acquiring historical operating data of the vehicle;
calculating data features of each relationship chain in the preset vehicle emission anomaly knowledge graph database using the Cosine similarity calculation strategy, based on the historical operating data, so as to obtain a plurality of Cosine similarity calculation results; ranking the plurality of Cosine similarity calculation results according to a preset ranking strategy, and taking the Cosine similarity calculation results meeting a preset ranking condition in the ranking results as the cause and probability of the vehicle emission anomaly.

15. The electronic device of claim 14, wherein prior to obtaining the cause and probability of the vehicle emission anomaly using the Cosine similarity calculation strategy, based on the preset vehicle emission anomaly knowledge graph database, the method comprises:
acquiring vehicle emission anomaly cause data;
forming a vehicle emission anomaly cause data relationship chain based on the vehicle emission anomaly cause data;
transforming the vehicle emission anomaly cause data relationship chain into entities and relationships in a knowledge graph using a preset knowledge graph theory; and
performing entity integration on relatively conflicting entities using an entity alignment strategy so as to obtain the preset vehicle emission anomaly knowledge graph database.
